(19) United States
(12) Patent Application Publication
(10) Pub. No.: US 2026/0023171 A1
(43) Pub. Date: Jan. 22, 2026

(54) Method for Performing Object Detection in a Component with a Locating Device

(71) Applicant: Robert Bosch GmbH, Stuttgart (DE)

(72) Inventor: Heiko Sgarz, Leonberg (DE)

(21) Appl. No.: 19/267,586

(22) Filed: Jul. 13, 2025

(30) Foreign Application Priority Data
Jul. 18, 2024 (DE) 10 2024 206 768.7

(51) Int. Cl. G01S 13/04; G01S 7/41

(52) U.S. Cl. CPC G01S 13/04; G01S 7/414

(57) ABSTRACT

A method for performing an object detection in a component with a locating device is disclosed. Also disclosed is a computer program, an apparatus, a storage medium, and a locating device for this purpose.

This application claims priority under 35 U.S.C. § 119 to application no. DE 10 2024 206 768.7, filed on Jul. 18, 2024 in Germany, the disclosure of which is incorporated herein by reference in its entirety.

The disclosure relates to a method for performing an object detection in a component with a locating device. The disclosure further relates to a computer program, an apparatus, a storage medium, and a locating device for this purpose.

### BACKGROUND

Locating devices, particularly radar locating devices, may use different channels, wherein the channels have different characteristics. For example, there may be a circular polarized channel that actually or virtually (mathematically calculated) emits a circular polarized wave. This channel has the characteristic that no or a relatively small background signal of a component, such as a wall (or floor or ceiling), is contained within it. The background signal can be understood to mean the signal that is present without the presence of an object, i.e., from the component structure itself.

Another channel is, for example, the co-polarization channel. This actually or virtually transmits a linearly polarized wave and receives it again in this polarization direction. Somewhat thicker or larger objects, in particular, can be located very well with this channel. However, associated with this, the channel has the disadvantage that it has a strong background signal, which in many cases consists primarily of the surface reflectance of the component. This strong background signal must usually be removed first in order to be able to detect objects thereafter. Otherwise, the background signal may be superimposed over the object signals.

When using channels at least with a strong background signal, therefore, this must generally be removed. This removal is carried out, for example, in that signals are received at different component positions. Accordingly, moving the locating device is necessary for this purpose. A background signal is then determined from these signals, e.g. by median formation, which can then be deducted from the signals in order to locate the object.

Since moving the device is necessary for this method, it cannot be used for the so-called spot view. In the spot view, the user places the locating device on the component and immediately gets a result. For the spot view, therefore, only channels in particular that have no or only a very small background signal can be used. However, this in turn restricts performance, because certain objects (e.g., large ones) are difficult to detect in these channels.

### SUMMARY

The subject of the disclosure is a method, a computer program, a device, a computer-readable storage medium, and a locating device having the features set forth below. Further features and details of the disclosure will emerge from the description and the drawings. Features and details which are described in connection with the method according to the disclosure naturally also apply in connection with the computer program according to the disclosure, the apparatus according to the disclosure, the computer-readable storage medium according to the disclosure as well as the locating device according to disclosure, and vice versa in each case, so that a reciprocal reference is always possible with regard to the disclosure of the disclosure.

The object of the disclosure is, in particular, a method for performing object detection in a component having a locating device, comprising the steps below, wherein the steps may be performed sequentially and/or in a particular order. The component can be, for example, a wall, a floor or a ceiling, for example, in a building. An object to be detected can be, for example, an electrical lead or a tube in the component.

The method according to the disclosure is in particular based on an analysis of radar data originating from the locating device, which emits a radar signal and detects reflections.

In a first step, preferably, radar data is provided, wherein the radar data results from a detection of a radar system of the locating device, wherein the radar system is disposed in an area of the component and emits a radar signal towards the component for the detection of the radar data. The fact that the radar system is disposed in an area of the component can in particular indicate that the radar system is present in a vicinity of the component, wherein, for example, the locating device can be applied to the component, for example against a surface of the component.

In a further step, preferably a first signal in the radar data which is specific for an earliest reflection in the radar data is determined based on an analysis of the radar data. For example, the first signal may be an increased signal strength, i.e. a spike in an amplitude, in the radar data. The first signal represents, for example, a surface of the component and may also be referred to as a background signal in the context of the present disclosure. Also, if an object is very close to the surface of the component and a resolution of the radar system is not sufficient, the first signal may comprise the signal which represents a reflection on a surface of the object.

In a further step, preferably the determined first signal is analyzed based on a comparison of the determined first signal with a first defined threshold value to perform the object detection. In particular, a signal strength or an amplitude is compared in this respect.

If the defined threshold value is not met, the following steps may also be performed.

In a further step, preferably the determined first signal is removed from the radar data to obtain filtered radar data. This may be done, for example, by subtracting the radar data representing the first signal from the remaining radar data.

In a further step, preferably a second signal is determined in the radar data which is specific for a reflection in the radar data which occurs second based on an analysis of the filtered radar data. The reflection which occurs second is thus represented in particular in the radar data at a later time. The second signal can be specific for the reflection which occurs second, for example due to an increased signal strength or amplitude.

In a further step, the determined second signal is preferably analyzed based on a comparison of the determined second signal with a second defined threshold value to perform the object detection. Here as well, in particular, a signal strength or an amplitude is compared.

A result of analyzing the determined first signal and/or analyzing the determined second signal can respectively indicate whether an object is present in the component or not. It is also contemplated that the result will comprise a size or thickness of the object, or also a type of the object, e.g. “tube”.

With the method according to the disclosure it may be possible to achieve accurate object detection in various scenarios. One scenario in this respect may be that an object is very close to a surface of the component, so that the resolution of the radar system is not sufficient to distinguish the object from a surface of the component. In a further scenario, the object, if one is present, is first disposed deeper in the component so that the reflection of the surface of the component can be filtered out before the object detection is performed.

It is contemplated that the determination of the first signal is carried out for two channels of the radar system and the removal of the determined first signal from the radar data as well as the determination of the second signal is performed only on a second channel of the radar system. Thus, redundant object detection may be performed, which may advantageously increase accuracy and reduce the susceptibility to failures. One of the channels, in particular the second channel, can be configured as a copolarization channel and the further channel as a circular polarized or cross-polarized channel. In a copolarization channel, in particular, a transmitting wave and a receiving wave have the same polarization. Advantageously, if the one channel is configured as a copolarization channel, thicker components with a higher signal-to-noise ratio can be detected than in circular polarized channels. This property may advantageously allow for more robust object location and better performance in environments with strong background signals.

The first defined threshold value and the second defined threshold value are preferably different to account for the removal of the determined first signal with the second defined threshold value. In other words, the second defined threshold value may be less than the expected amount of the first determined signal, which may be determined based on, for example, a previous analysis or calibration. Further, different threshold values may make it possible to adapt a signal processing to specific applications. This flexibility may advantageously make it possible to improve the accuracy and efficiency of object detection.

The method may also further comprise the following step:
Initiating a display of the result on a display of the locating device.
   Thus, a user may be directly informed as to whether there is an object in the component and take appropriate measures, for example to search for an alternative position for a bore.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

The disclosure also comprises a locating device for performing an object detection in a component comprising a radar system and a display. The locating device may be configured to perform the steps of the method according to the disclosure.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a device, a storage medium, and a computer program according to exemplary embodiments of the disclosure,

FIG. 2 a schematic representation of a locating device having a radar system and a display as well as a component having an object according to exemplary embodiments of the disclosure.

### DETAILED DESCRIPTION

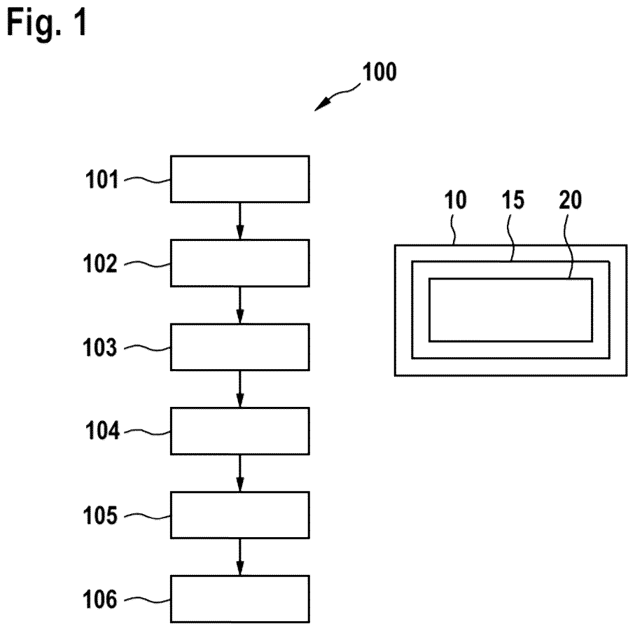

FIG. 1 schematically illustrates a method 100, a device 10, a storage medium 15, and a computer program 20 according to exemplary embodiments of the disclosure.

In particular, FIG. 1 shows an exemplary embodiment for a method 100 for performing an object detection in a component 1 with a locating device 2. In a first step 101, radar data is provided, wherein the radar data results from a detection of a radar system 3 of the locating device 2, wherein the radar system 3 is disposed in an area of the component 1 and emits a radar signal towards the component 1 for the detection of the radar data. In a second step 102, a first signal in the radar data which is specific for an earliest reflection in the radar data is determined based on an analysis of the radar data. In a third step 103 the determined first signal is analyzed based on a comparison of the determined first signal with a first defined threshold value to perform the object detection. If the defined threshold value is not met, the following steps are also performed. In a fourth step 104, the determined first signal is removed from the radar data to obtain filtered radar data. In a fifth step 105, a second signal is determined in the radar data which is specific for a reflection in the radar data which occurs second based on an analysis of the filtered radar data. In a sixth step 106, the determined second signal is analyzed based on a comparison of the determined second signal with a second defined threshold value to perform the object detection.

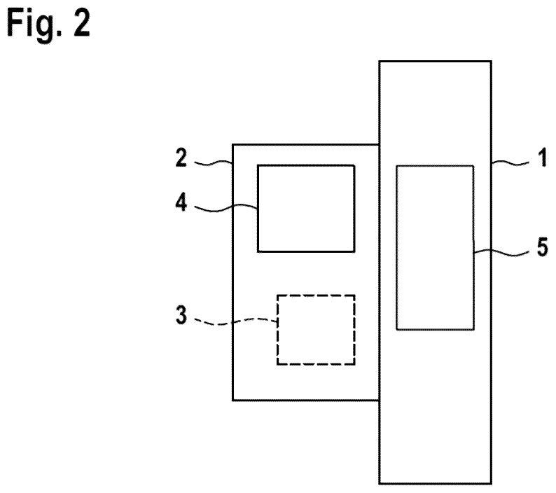

FIG. 2 shows a locating device 2 with a radar system 3 and a display 4 as well as a component 1 with an object 5 according to exemplary embodiments of the disclosure.

The method according to exemplary embodiments makes it possible in particular to process channels and/or radar data with a non-negligible background signal, which can thereby be advantageously used in a spot view application. The spot view application is in particular an application in which the locating device remains on a position without moving to perform the object detection. For this purpose, the background signal, i.e. in particular a reflection of a surface of the component, is preferably estimated from the radar data even at a single position and then removed from radar data in order to perform the object detection. In this way, a device can advantageously be realized which uses at least one channel with a background deduction, i.e., a removal of the first, or background signal for a spot view. This channel is preferably always available without the device having been previously moved on the material or component. In addition, at least one channel without a background deduction, i.e., without removing the first, or background signal may be used.

First, it can be determined which signals the radar data consists of. If one considers a component, such as a wall, a floor or a ceiling, as a homogeneous layer of thickness d, one obtains in particular the following two reflection points. A first reflection point, i.e., in particular the first signal in the context of the present disclosure, can be a transition between the air and the material or the component. Since this is the first reflection point and the radar data have also not yet been attenuated by the material, for example, the resulting signal can be very large and dominate all the other signals. A second reflection point may exist at a transition to the object. If there is no object in the component, a second reflection point can be a transition between the material or the component to the air at the rear of the layer (e.g., component). Depending on the thickness of the component, this transition may no longer even be in the observed range (depth) of the locating device. In any case, the signal may be significantly smaller than that of the first reflection point due to the attenuation in the component and usually also smaller than signals caused by objects in the component.

In many cases, it may be sufficient to estimate a reflection factor of the first reflection point. This reflection factor can be cut off, e.g., in the time range of further reflections, for instance, by objects or by rear reflectance, and then removed from the radar data to perform the object detection.

Cutting it off may become difficult when an object is close to a surface in the component. In this case, a resolution of the locating device or radar system of the locating device may no longer be sufficient to separate the surface reflection of the first reflection point and a reflection of the object from one another. To address this problem, in addition to the at least one channel with a background deduction, i.e. the removal of the first, or background signal, at least one channel without a background deduction is used. If an object in the channel is already detected at a position without a background deduction, it is possible that the background deduction may not be able to be determined because the object has already been detected. In those instances where an object is close to the surface and the abovementioned problem would arise, it is likely that the object can already be detected in a channel without background deduction. The background deduction corresponds in particular to the removal of the determined first signal according to exemplary embodiments of the disclosure.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for performing object detection in a component with a locating device, comprising:
providing radar data, wherein the radar data results from a detection of a radar system of the locating device, and wherein the radar system is disposed in an area of the component and emits a radar signal towards the component for the detection of the radar data;
determining a first signal in the radar data which is specific for an earliest reflection in the radar data based on an analysis of the radar data; and
analyzing the determined first signal based on a comparison of the determined first signal with a first defined threshold value to perform the object detection,
wherein, if the threshold value is below the defined threshold, the following steps are further performed:
removing the determined first signal from the radar data to obtain filtered radar data;
determining a second signal in the radar data which is specific for a second reflection in the radar data based on an analysis of the radar data; and
analyzing the determined second signal based on a comparison of the determined second signal with a second defined threshold value to perform the object detection.

2. The method according to claim 1, wherein the determination of the first signal is performed for two channels of the radar system, and wherein removing the determined first signal from the radar data as well as determining the second signal are performed only on a second channel of the radar system.

3. The method according to claim 2, wherein one of the channels is configured as a copolarization channel and the further channel is configured as a circular polarized or cross-polarized channel.

4. The method according to claim 1, wherein the component is a wall, a floor, or a ceiling.

5. The method according to claim 1 wherein the first defined threshold value and the second defined threshold value are different to account for the removal of the determined first signal with the second defined threshold value.

6. The method according to claim 1, wherein a result of analyzing the determined first signal and/or analyzing the determined second signal indicates whether or not an object is present in the component.

7. The method according to claim 6, further comprising:
initiating display of the result on a display device of the locating device.

8. A computer program comprising commands for causing the computer to carry out the method according to claim 1 when the computer program is executed by a computer.

9. A device for data processing, configured to carry out the method according to claim 1.

10. A computer-readable storage medium, comprising commands which, when executed by a computer, cause said computer to carry out the steps of the method according to claim 1.

11. A locating device for performing object detection in a component comprising a radar system and a display device, wherein the locating device is configured to perform the steps of the method of claim 1.

12. The method according to claim 3, wherein the one of the channels is the second channel.
